(19) United States
(12) Patent Application Publication
(10) Pub. No.: US 2022/0153946 A1
(43) Pub. Date: May 19, 2022

(54) METHOD OF MANUFACTURING FLEXIBLE PRESSURE SENSOR HAVING CONCENTRATION GRADATION PROFILE

(71) Applicant: ELECTRONICS AND TELECOMMUNICATIONS RESEARCH INSTITUTE, Daejeon (KR)

(72) Inventors: Jeong Hun KIM, Daejeon (KR); Seung Eon MOON, Daejeon (KR); Jong Pil IM, Daejeon (KR)

(73) Assignee: ELECTRONICS AND TELECOMMUNICATIONS RESEARCH INSTITUTE, Daejeon (KR)

(21) Appl. No.: 17/528,006

(22) Filed: Nov. 16, 2021

(30) Foreign Application Priority Data
Nov. 17, 2020 (KR) 10-2020-0153916
Nov. 11, 2021 (KR) 10-2021-0154430

(51) Int. Cl. C08J 7/04; G01L 9/06

(52) U.S. Cl. CPC C08J 7/0427; G01L 9/06; C08J 2435/02; C08J 2367/02; C08J 2379/08

(57) ABSTRACT

The present disclosure provides is a method of manufacturing a flexible pressure sensor by forming the polymer support and the conductive particles from a single uniform solution and performing a curing of the polymer support and a growth of the conductive particles in a continuous process. The method of manufacturing a flexible pressure sensor includes: preparing a solution by adding a polymer support material, a conductive particle, and a photoinitiator to a solvent; applying the solution on a flexible substrate; and irradiating ultraviolet rays onto the solution applied on the flexible substrate to cure the solution and form a solid film.

### CROSS-REFERENCE TO RELATED APPLICATION

The present application claims convention priorities based on Korean Patent Application No. 10-2020-0153916 filed on Nov. 17, 2020, and No. 10-2021-0154430 filed on Nov. 11, 2021, with the Korean Intellectual Property Office (KIPO), the entire contents of which are incorporated herein by reference.

### BACKGROUND

### 1. Technical Field

The present disclosure relates to a method of manufacturing a pressure sensor and, more particularly, to a method of manufacturing a piezoresistive flexible pressure sensor using a photo-curable polymer.

### 2. Related Art

A pressure sensor is a measurement device capable of changing a magnitude of an applied physical force into an electrical signal and may be applied in various fields such as process equipment, automobiles, home appliances, and smart devices. With the popularization of wearable devices and the growth of the healthcare industry, research is being conducted to develop a pressure sensor applicable to a human body to detect a movement or a biometric signal of a user. A pressure sensor that may be attached to the human body and capable of detecting an accurate signal is essential to measure a pulse, body temperature, electrocardiogram, and so on of the human body. A most common industrial pressure sensor may be a microelectromechanical system (MEMS) sensing device manufactured by a semiconductor fabrication process. However, the MEMS sensing device is not flexible and may be inapplicable to a curved human body. Further, the manufacturing of the MEMS sensing device requires expensive equipment such as a vacuum deposition apparatus. Accordingly, efforts are being made to develop a flexible pressure sensor based on polymer materials.

A piezoresistive polymer pressure sensor which may be a most common type flexible pressure sensor is manufactured by forming a layer of complex materials including conductive metal particles, wires, carbon nanotubes, and two-dimensional materials through which electrons can move on a flexible support made of a polymer material. The piezoresistive polymer pressure sensor has characteristics that the electrical resistance varies according to the deformation of a contact area by a pressure and may measure the applied pressure by using the characteristics. However, the polymer support and materials for the complex layer including the conductive particles should be prepared separately to manufacture the polymer pressure sensor. Further, it is difficult to repeatedly fabricate the pressure sensor having uniform characteristics because the complex materials dispersed sufficiently may be prepared by complicated processes including a physical dispersion such as ultrasonic treatment, for example, and an addition of chemical additives. Even worse, the polymer material in a liquid state and the conductive particles in a solid state have different properties in the complex flow before the curing, and it is difficult to apply them to a precision process such as a microstructure formation.

### SUMMARY

In order to solve the problem of preparing the polymer support and conductive particles required for the flexible pressure sensor separately during a manufacturing process and additionally performing a dispersion process, provided is a method of manufacturing a flexible pressure sensor by forming the polymer support and the conductive particles from a single uniform solution and performing a curing of the polymer support and a growth of the conductive particles in a continuous process.

According to an aspect of an exemplary embodiment, a method of manufacturing a flexible pressure sensor includes: preparing a solution by adding a polymer support material, a conductive particle, and a photoinitiator to a solvent; applying the solution on a flexible substrate; and irradiating ultraviolet rays onto the solution applied on the flexible substrate to cure the solution and form a solid film.

The solvent may include water or an organic solvent.

The polymer support material may include an acrylic material. In particular, the polymer support material may include poly(ethylene glycol) diacrylate) (PEGDA).

The conductive particle may include a metal particle precursor in an ion state.

The metal particle precursor may be AgNO₃, AgCF₃COO, AuCl₃, HAuCl₄, CuSO₄, or a combination thereof.

A content of the photoinitiator added to the solution may be less than 1 weight percent (wt %) of a content of the polymer support material.

The flexible substrate may be made of polyimide (PI) or polyethylene terephthalate (PET) material.

The step of irradiating the ultraviolet rays onto the solution to cure the solution may include steps of irradiating the ultraviolet rays of a first energy level onto the solution; and irradiating the ultraviolet rays of a second energy level, onto the solution, which is higher than the first energy level as a curing of the solution progresses.

The flexible pressure sensor manufactured according to an exemplary embodiment may have a gradation-profiled structure that a density of the metal silver particles is highest at a surface of the flexible film and gradually decreases toward a bottom.

The method of manufacturing the flexible pressure sensor according to an exemplary embodiment of the present disclosure is based on optical curing and light reduction processes performed at room temperature and atmospheric pressure, and enables to manufacture the flexible pressure sensor at low manufacturing costs and facilitate the manufacturing of a large-sized sensor.

The flexible pressure sensor manufactured by the method according to an exemplary embodiment of the present disclosure may be applied to a curved surface and may have a high flexibility and durability. A microstructure of the flexible film may be controlled easily by adjusting an energy of the ultraviolet rays during a process of growing the conductive particles. Thus, the operating characteristics including a sensitivity of the flexible sensor may be changed easily.

### BRIEF DESCRIPTION OF THE DRAWINGS

In order that the disclosure may be well understood, there will now be described various forms thereof, given by way of example, reference being made to the accompanying drawings, in which:

FIG. 1 is a flowchart illustrating a method of manufacturing a flexible pressure sensor according to an exemplary embodiment of the present disclosure;

FIG. 2A is an illustration of polymer support material particles, metal ions, and photoinitiator particles dispersed in a solution before a curing of the solution;

FIG. 2B is an illustration of a cross section of a metal-polymer composite film formed after the curing of the solution;

FIGS. 3A and 3B are exemplary photographs of a surface of a solution before a curing and a surface of a film after the curing, respectively;

FIG. 4 is an illustration of an operation principle of the flexible pressure sensor according to an exemplary embodiment of the present disclosure; and

FIGS. 5A and 5B are graphs showing resistance changes of the flexible pressure sensor according to changes in applied pressures, where FIG. 5A shows a resistance change of the flexible pressure sensor in response to repeated soft touches of a user, and FIG. 5B shows a resistance change of the flexible pressure sensor according to an increase in a weight of the touch.

The drawings described herein are for illustration purposes only and are not intended to limit the scope of the present disclosure in any way.

### DETAILED DESCRIPTION

For a more clear understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure. In the drawings, similar or corresponding components may be designated by the same or similar reference numerals.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Exemplary embodiments of the present disclosure will now be described in detail with reference to the accompanied drawings. In the following description and the drawings, similar or corresponding components may be designated by the same or similar reference numerals to facilitate an overall understanding of the present disclosure and replicate description of them will be omitted for simplicity.

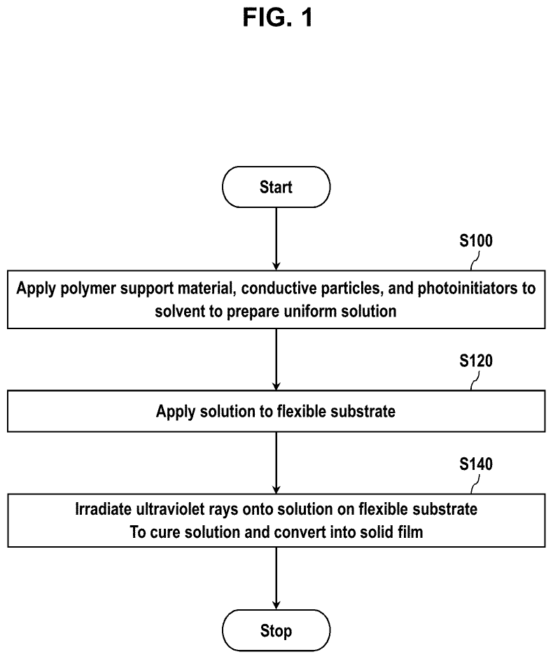

FIG. 1 is a flowchart illustrating a method of manufacturing a flexible pressure sensor according to an exemplary embodiment of the present disclosure.

First, polymer support material, conductive particles, and photoinitiators are applied to a solvent, and then the mixture are stirred using a stirrer to prepare a uniform solution (step 100).

Water or an organic solvent may be used as the solvent. In particular, distilled water may be used as the solvent.

The polymer support material may include an acrylic material, e.g. poly(ethylene glycol) diacrylate (PEGDA), which may be dissolved in the water or the organic solvent and may be cured by a radical reaction.

The conductive particles may be metal particles. A material that may be dissolved in the solvent with the polymer support material and include ions of gold, silver, copper, and the like capable of growing into respective particles through a reduction reaction may be used as a precursor of the metal particles. An example of the precursor of the metal particles may include silver nitrate (AgNO₃). However, the present disclosure is not limited thereto, and another material such as trifluoroacetate (AgCF₃COO), gold trichloride (AuCl₃), hydrogen tetrachloroaurate (HAuCl₄), copper(II) sulfate (CuSO₄) may be used as the precursor of the metal particles with or instead of the silver nitrate (AgNO₃).

The photoinitiator, which may generate radicals when ultraviolet rays are irradiated, may include Irgacure 2959 provided by Ciba Inc., Switzerland (‘Irgacure’ is a trademark of the Ciba Inc.). In addition, a photoinitiator candidate group may include Irgracure 184, 500, 754, and 819 and Darocur 1173, 4265, and the like (‘Darocur’ is a trademark of the Ciba Inc.). A content of the photoinitiator may be less than 1 weight percent (wt %) of that of the polymer support material.

After the step 100, the solution prepared s above may be applied to a flexible substrate to fabricate the solution into a desired flexible film (step 120). Polyimide (PI) or polyethylene terephthate (PET), for example, may be used as the flexible substrate. The application or deposition of the solution on the flexible substrate may be performed by a general film forming method such as a spin coating, screen printing, doctor blading, molding, and so on to obtain a film of a uniform thickness.

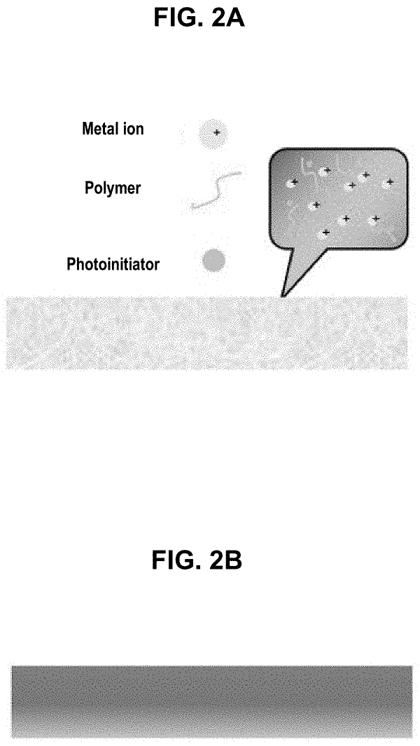

Subsequently, the ultraviolet rays are irradiated onto the solution applied to the flexible substrate, so that the solution may be cured and converted into a solid film (step 140). Through the curing process, the solution in which the polymer support material particles, the metal ions, and the photoinitiator particles are dispersed as shown in FIG. 2A may be changed into a metal-polymer composite film shown in FIG. 2B.

The curing of the polymer and the reduction of the ions are may proceed by the radicals. Thus, the manufacturing method of the present disclosure uses optical curing and light reduction processes based on ultraviolet rays which may be initiated at room temperature and atmospheric pressure. The wavelength of the ultraviolet ray may be in the range of 254-405 nanometers (nm). For example, ultraviolet rays of 365 nm wavelength may be used for the polymer curing. The energy of the ultraviolet rays may be selected from a low energy range of, e.g. 1-50 mW/cm² at a beginning of the curing process to prevent a possible crack of the flexible film. As the curing process progresses, however, the energy of the ultraviolet rays may increases to a higher energy level such as 300 mW/cm². The increased energy level may be adjusted within a certain range that does not affect the film structure.

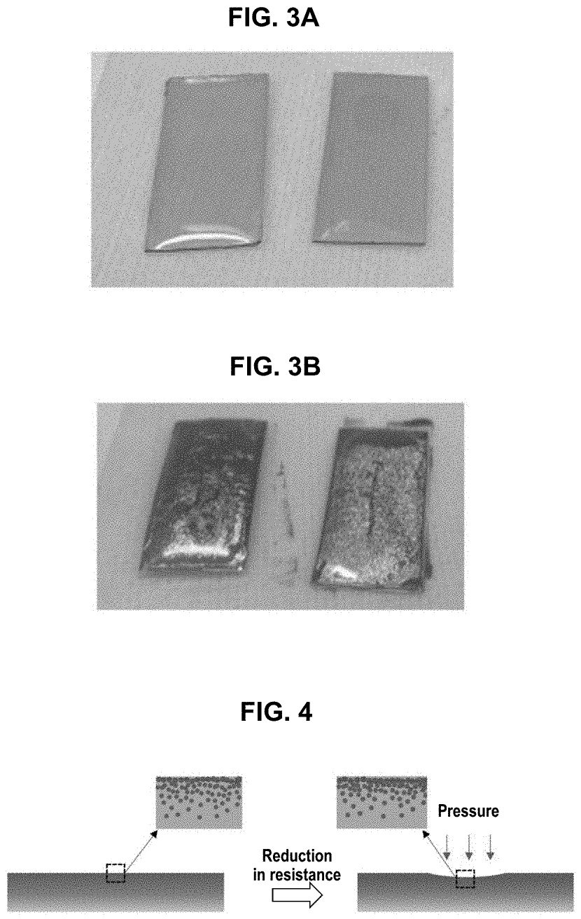

As the high-energy ultraviolet rays are continuously irradiated, a generation of radicals continues and silver cations in the solution are reduced to silver particles. Accordingly, a color of a surface of the solution is gradually changed to a unique color of the metal and a resistance of the resulting film decreases over time. FIGS. 3A and 3B show the surface of the solution before the curing and the surface of the film after the curing, respectively. It can be seen that a transparent or pale yellow surface of the solution before the curing changes into a metallic color by the reduction of the silver ions after the continuous irradiation of the ultraviolet rays.

According to the method of manufacturing the flexible pressure sensor according to the present disclosure, the curing of the polymer support and the growth of the conductive particles may be performed in a continuous process or at the same time.

FIG. 4 shows an operation principle of the flexible pressure sensor according to an exemplary embodiment of the present disclosure. The silver ions distributed near the surface of the solution are actively reduced by the ultraviolet rays, but the reduced silver particles lower the transmittance of the ultraviolet rays and prevent the reduction reaction of the silver ions in the lower portion of the solution. Accordingly, a density of the silver particles is highest at the surface of the flexible solid film and gradually decreases toward the bottom. Due to such a concentration gradation-profiled structure, an external pressure applied to the flexible solid film may change a contact area between the reduced silver particles and a resultant resistance of the film. Thus, the flexible film may work as a pressure sensor.

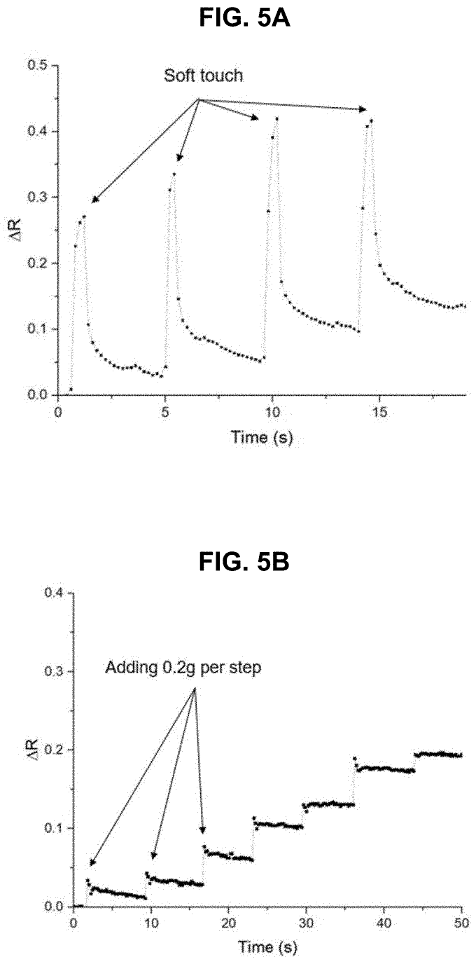

FIGS. 5A and 5B are graphs showing resistance changes of the flexible pressure sensor according to changes in applied pressures. In detail, FIG. 5A shows a resistance change of the flexible pressure sensor in response to repeated soft touches of a user, and FIG. 5B shows a resistance change of the flexible pressure sensor according to an increase in a weight of the touch. It can be seen in FIG. 5A that the resistance changes regularly and repeatedly in response to the repeated soft touches of the user. It can be seen in FIG. 5B that the resistance increases by a uniform value whenever the weight of the touch is increased by 0.2 gram.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of manufacturing a flexible pressure sensor, comprising:
preparing a solution by adding a polymer support material, a conductive particle, and a photoinitiator to a solvent;
applying the solution on a flexible substrate; and
irradiating ultraviolet rays onto the solution applied on the flexible substrate to cure the solution and form a solid film.

2. The method of claim 1, wherein the solvent comprises water or an organic solvent.

3. The method of claim 1, wherein the polymer support material comprises an acrylic material.

4. The method of claim 3, wherein the polymer support material comprises poly(ethylene glycol) diacrylate) (PEGDA).

5. The method of claim 1, wherein the conductive particle comprises a metal particle precursor in an ion state.

6. The method of claim 5, wherein the metal particle precursor is one selected from a group consisting of AgNO₃, AgCF₃COO, AuCl₃, HAuCl₄, CuSO₄, and a combination thereof.

7. The method of claim 1, wherein a content of the photoinitiator added to the solution is less than 1 weight percent (wt %) of a content of the polymer support material.

8. The method of claim 1, wherein the flexible substrate is made of polyimide (PI) or polyethylene terephthalate (PET) material.

9. The method of claim 1, wherein irradiating the ultraviolet rays onto the solution to cure the solution comprises:
irradiating the ultraviolet rays of a first energy level onto the solution; and
irradiating the ultraviolet rays of a second energy level, onto the solution, which is higher than the first energy level as a curing of the solution progresses.
